(19) United States
(12) Patent Application Publication
(10) Pub. No.: US 2009/0224897 A1
(43) Pub. Date: Sep. 10, 2009

(54) Vehicle vision system

(76) Inventor: Tien-Bou Wan, Tainan City (TW)

Correspondence Address: Tien-Bou, Wan, Sec. 2, No. 2, Alley 492, Hai Tien, THINAN, 709, TW

(21) Appl. No.: 12/074,309

(22) Filed: Mar. 4, 2008

(51) Int. Cl. H04N 7/18; B60Q 1/00

(52) U.S. Cl. 340/436; 348/148; 348/E07.085

(57) ABSTRACT

The present invention of vehicle vision system consists of a central processing unit installed inside the vehicle, a front video device, a reversing video device and an event data recorder. The front video device equipped at the vehicle front is provided for detecting the lane departure and the distance of the front vehicle. The reversing video device is mounted to the vehicle rear and coupled with a steering angle device to provide auxiliary drawing line on a monitor for assisting the driver when reversing. In the event of the accident, the event data recorder automatically or manually memorizes the image information at the collision scene.

### BACKGROUND OF THE PRESENT INVENTION

1. Field of the Invention

The present invention relates to a vision system, more particularly to an integrated vision system applied for vehicles.

2. Description of Related Invention

A conventional vehicle vision device includes some disadvantages as follows. Firstly, such device is unable to detect the lane departure and activate the warning signal or monitor the safety distance from the front end. Secondly, the reversing vision captured from the video device is merely displayed on the monitor; accordingly the driver could only analyze the reversing angle by their own experience without the indication of direction reference. Thirdly, there is no event data recording apparatus installed to record the information related to the vehicle condition in the traffic accident or traffic offense.

### SUMMARY OF THE PRESENT INVENTION

In view of the foregoing disadvantages, the present invention provides a vehicle vision system, comprising a central processing unit, a front video device, a reversing video device and an event data recorder. The front vision device supports detecting the lane departure of the vehicle and the safety distance so as to activate the warning signal accordingly. The reversing vision device coupled with a steering angle sensor enables an auxiliary drawing line according to the spinning angle of the steering wheel being displayed on the monitor for direction indication. An event data recorder equipped with acceleration sensor device serves to memorize the image information related to the vehicle condition at the collision scene.

### BRIEF DESCRIPTION OF THE DRAWINGS

FIG. 1 is a system flow diagram of the preferred embodiment of the present invention.

### DETAILED DESCRIPTION OF THE PREFERRED EMBODIMENT

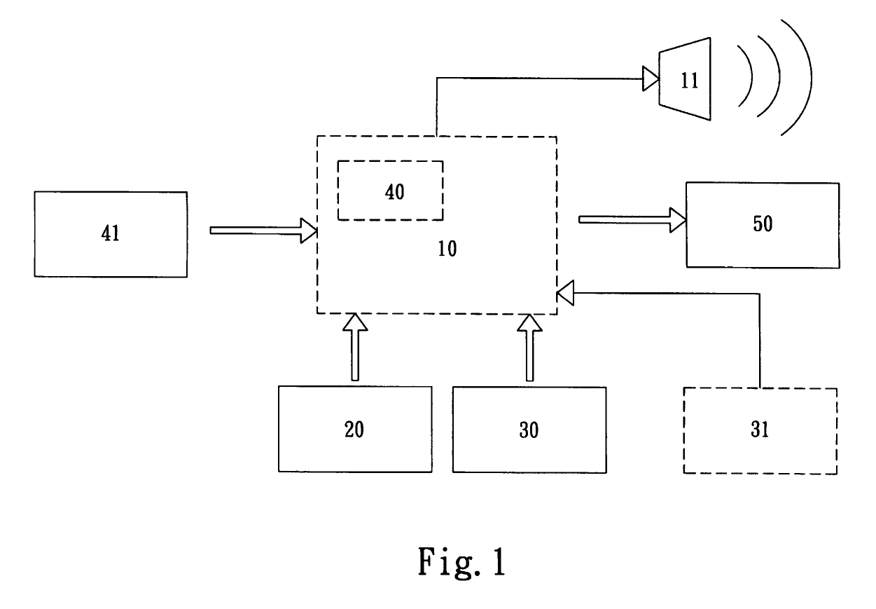

Referring to FIG. 1 of the drawings, the present invention relates to a vehicle vision system, comprising a central processing unit (10), a front video device (20), a reversing video device (30), and an event data recorder (40). The central processing unit (10) is mounted inside the vehicle for analyzing the information of the traffic condition captured from the front video device (20), the reversing video device (30) and the event data recorder (40). The front vision device (20) is mounted to the front area of the vehicle enabling the activation of the warning signal when the lane departure happens or being too close form the front vehicle so as to avoid from the collision. The reversing video device (30) is installed at the vehicle rear with a steering angle sensor (31) connected inside to assist the driver reversing the vehicle, wherein an auxiliary line according to the reversing angle is displayed on the monitor (20) equipped in front of the driver. The event data recorder (40) with an acceleration sensor (41) coupling to enables to capture the image information related to the vehicle's condition in the traffic accident automatically or manually.

The front video device (20) is used for detecting the raw rate of the lane departure and transmitting the information regarding driving speed and the distance of the front vehicle into the central processing unit (10). If the vehicle departures from the lane or gets too close from the front vehicle, the central processing unit (10) activates the warning device (11) to make the alert sound. The steering angle sensor (31) coupled to the reversing video device (30) enables to calculate the spinning angle of the wheel and convert into a drawing line displayed on the monitor (50) so as to provide the direction indication for the driver. The event data recorder (40) with the acceleration sensor (41) installed inside is provided for memorizing the image information of the vehicle's condition in a traffic accident or traffic offense at the scene.

What is claimed is:

1. A vehicle vision system, comprising a central processing unit installed inside the vehicle for capturing information of the traffic condition and configuring it to a front video device, a reversing video device and an event data recorder, wherein said front video device is installed in front of the vehicle for detecting the speed and the distance of the front vehicle and the rate of lane departure so as to avoid from the collision; said reversing video device is installed at vehicle rear coupling with a steering angle sensor for assisting the driver when reversing by providing an auxiliary drawing line displayed on a monitor; said event data recorder is coupled with an acceleration sensor for memorizing the image information related to the vehicle condition in a traffic accident or traffic offense automatically or manually.
